(19) United States
(12) Patent Application Publication
(10) Pub. No.: US 2009/0217663 A1
(43) Pub. Date: Sep. 3, 2009

(54) METHOD AND DEVICE FOR CONTROLLING SUPERCHARGING AIR OF AN INTERNAL COMBUSTION ENGINE

(75) Inventors: Emmanuel Buis, Sceaux (FR); Arnaud Guinois, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S, Boulogne Billancourt (FR)

(21) Appl. No.: 12/280,371

(22) PCT Filed: Feb. 5, 2007
(86) PCT No.: PCT/FR2007/050748

§ 371 Date: Dec. 24, 2008

(30) Foreign Application Priority Data
Feb. 28, 2006 (FR) 0601758

(51) Int. Cl. F02D 23/00

(52) U.S. Cl. 60/602

(57) ABSTRACT

A control method including regulating air pressure prevailing in an engine intake manifold around a setpoint value. The regulating includes a slow regulation loop, a fast regulating loop, and a limitation of pressure upstream of a turbine of a supercharger. The supercharging pressure limitation is implemented when the pressure upstream of the turbine exceeds a predetermined threshold value.

The invention relates to the control of internal combustion engines of motor vehicles.

More particularly, the invention relates to the control of the supercharging of such engines with air.

A particularly valuable application of the invention relates to the control of the supercharging with air of an engine of the diesel type supercharged by a turbocharger.

The control of the engine is the technique for regulating the performance of an internal combustion engine by piloting all of its sensors and actuators.

All the laws of control and parameters of piloting the engine are contained in a computer called the ECU or electronic control unit.

Supercharged engines comprise a turbocharger comprising a turbine rotated by the exhaust gases and a compressor driven by the turbine and used to increase the quantity of air admitted into the cylinders.

Accordingly, the turbine is placed at the outlet of the exhaust manifold while the compressor is mounted on the same shaft as the turbine and is placed upstream of the inlet manifold.

The power provided by the exhaust gases to the turbine may be regulated by installing a waste gate or fins which influence the gas flow rate passing through the turbine or the passageway section offered to these gases.

An actuator is used to pilot the opening and closing of the waste gate or of the fins under the control of a control signal delivered by the electronic control unit in order to slave the supercharging pressure prevailing in the inlet manifold onto a pressure set point computed by the ECU.

The ECU incessantly recomputes the supercharging pressure set point, as a function of the engine speed and of the fuel flow rate, or else based on an air flow rate and richness set point, and controls the waste gate or the fins in order to make the pressure prevailing in the inlet manifold and set point pressure coincide.

With the increase in supercharged engine performance, the supercharging pressure level is increasing so that the turbochargers are increasingly put under strain. It is therefore important to pilot the turbochargers as accurately as possible in order to prevent their deterioration and improve the behavior of the vehicle during accelerations, and in particular to increase the dynamics of the engine, that is to say its capacity to speed up quickly.

When the driver wants to have maximum engine power, he presses the accelerator pedal right down. This position of the pedal is converted by the ECU into a fuel flow rate set point. This flow rate set point is then limited to transitional by a threshold which is a function of the cool air flow rate and the engine speed, in order to limit the particle emissions (black smoke) present in the engine exhaust gases when it is operating at transitional speed.

Since clean air standards are increasingly strict, the quantity of particles discharged by an engine, particularly a diesel, has to be increasingly small. This is why the engine exhaust line is provided with a particle filter which makes it possible to reduce the quantity of particles discharged into the environment. The introduction of such a device produces an increase in the exhaust back pressure. This back pressure becomes greater as the filter is filled with particles. This results, with respect to the turbocharger, in a reduction in the expansion ratio and in a resultant reduction of the power provided by the exhaust gases to the turbine and a diminution of engine performance. To obtain the same level of performance, it is necessary to maintain the expansion ratio by increasing the pressure upstream of the turbine. This increase is usually obtained by closing the waste gate or acting on the fins.

The regulation of the pressure prevailing in the engine inlet manifold around the pressure set point value is traditionally achieved by means of PID (Proportional, Integral, Differential) regulators according to the evolution of the difference between the pressure set point and the actual measured pressure.

However, this regulation strategy is difficult to apply because it must make it possible to slave the pressure prevailing in the manifold to the pressure set point at both stabilized speed and at transitional speed.

In the prior art, an attempt has already been made to achieve this objective.

It is possible in this respect to refer to document US 2003/00 100 19 which uses two regulators in a cascade or to document FR 2 829 530 which proposes regulating the pressure value upstream of the turbocharger turbine around a pressure set point value corresponding to a maximum pressure value authorized upstream of the turbocharger turbine.

It is also possible to refer to document WO 2004/00 99 84 which proposes controlling the supercharging by using a position set point which is a function of the engine speed or to document WO 2004/027 238 which proposes regulating in a sequential manner either the supercharging pressure, or the position of an actuator for regulating the power of the exhaust gases.

But the solutions proposed in the prior art do not make it possible to apply a control of the supercharging pressure in order to control precisely the pressure prevailing in the inlet manifold of the engine at both stabilized speed and transitional speed, while limiting the pressure upstream of the turbocharger in order to protect the engine and the turbocharger.

The object of the invention is therefore to remedy these disadvantages and provide a method and a device for controlling the supercharging of a supercharged internal combustion engine making it possible to achieve this triple objective, namely control of the supercharging pressure at transitional speed, control of the supercharging pressure at stabilized speed and limitation of the pressure upstream of the turbine.

The subject of the invention is therefore, according to a first aspect, a method for controlling the supercharging with air of an internal combustion engine of a motor vehicle fitted with a supercharging turbocharger comprising a turbine rotated by the exhaust gases of the engine and a supercharging compressor driven by the turbine, the method comprising the regulation of the pressure prevailing in an inlet manifold of the engine around a set point value of supercharging pressure.

This method also comprises a regulation of the pressure upstream of the turbine to limit said pressure upstream of the turbine, the regulation being applied as soon as the pressure upstream of the turbine exceeds a predetermined threshold value.

In addition, the regulation of the pressure in the inlet manifold comprises a slow regulation and a fast regulation.

The regulation of the pressure upstream of the turbine is deactivated as soon as the pressure prevailing in the manifold is greater than the supercharging pressure set point value.

According to another feature of the invention, the slow regulation comprises a phase of generating a supercharging pressure set point and a regulation of the manifold pressure around the set point value.

For example, the set point value is extracted from a cartography element. It is generated as a function of the engine speed and the fuel flow rate.

It is also possible to correct the set point value as a function of ambient parameters, such as the temperature and atmospheric pressure.

In one embodiment, the regulation of the pressure prevailing in the manifold is applied by means of a fuzzy logic or a regulator of the PID type.

It is also possible advantageously to preset a member for adjusting the power of the exhaust gases at a predetermined position extracted from a cartography element based on a value of operating parameters of the engine.

These operating parameters can comprise the engine speed and the fuel flow rate.

According to another feature of the invention, switching of the operation from slow regulation to open loop when the engine operates at transitional speed is provided.

According to a second aspect, the invention relates to a device for controlling the supercharging with air of an internal combustion engine of a motor vehicle fitted with a supercharging turbocompressor provided with a turbine driven by the exhaust gases of the engine and a supercharging compressor driven by the turbine, the device comprising an electronic control unit comprising means for regulating the pressure prevailing in an inlet manifold of the engine around a supercharging pressure set point value, characterized in that the means for regulating the pressure prevailing in the manifold comprise a slow regulation loop and a fast regulation loop, and in that the electronic control unit also comprises regulation means suitable for limiting the pressure value upstream of the turbine, said regulation being applied as soon as the pressure upstream of the turbine is greater than a threshold value.

According to another feature of this device, the slow regulation loop comprises means for generating a supercharging pressure set point value based on operating parameters of the engine and means for slaving the manifold pressure around the threshold value.

For example, said means for slaving the pressure prevailing in the manifold around the threshold value comprise a fuzzy logic element or a PID regulator.

According to yet another feature of the device according to the invention, a cartography element is used in which are stored preposition values of a member for regulating the power of the exhaust gases as a function of operating parameters of the engine and of the means for prepositioning said member based on a value extracted from the cartography element.

According to yet another feature of the invention, the device also comprises means for selectively commanding the operation from the slow regulation loop to closed loop or to open loop as a function of the transitional or stabilized speed of the engine.

Other objects, features and advantages of the invention will appear on reading the following description, given only as a nonlimiting example, and made with reference to the appended drawings in which:

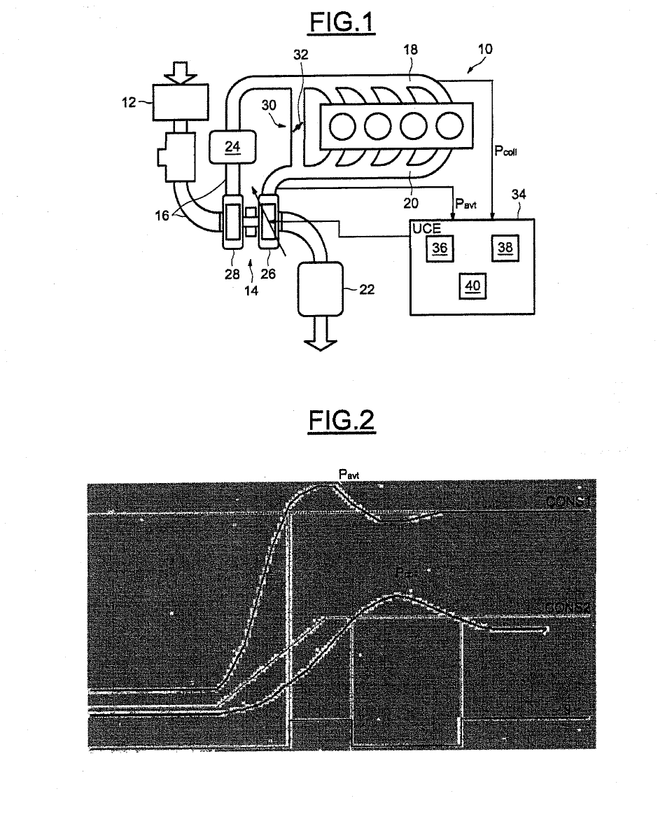

FIG. 1 illustrates schematically the structure of an internal combustion engine, of the diesel type, of a motor vehicle provided with a supercharging control device according to the invention;

FIG. 2 shows the curves illustrating the use of the regulation of the pressure prevailing in the engine inlet manifold and the pressure upstream of the turbine, as a function of the measured or estimated values of the pressures upstream of the turbine and in the inlet manifold;

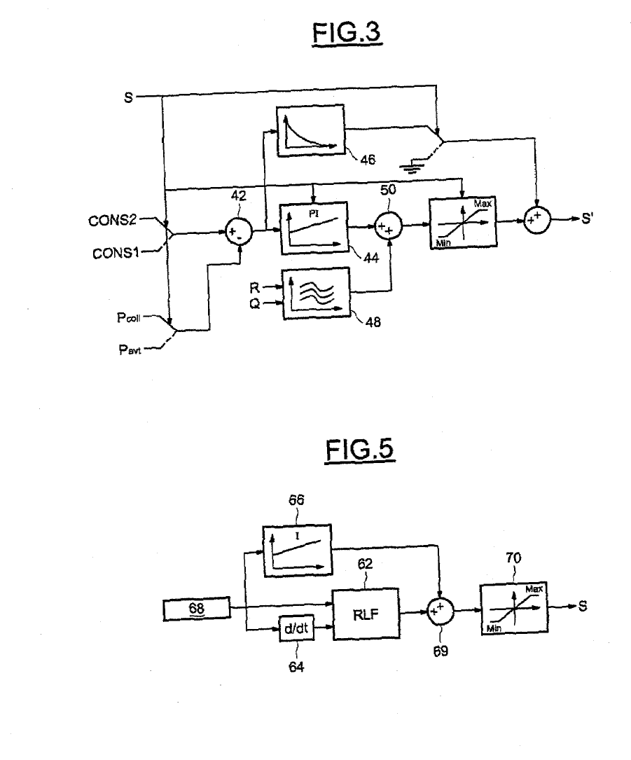

FIG. 3 is a block diagram illustrating the architecture of the slow loop of the inlet manifold pressure regulator;

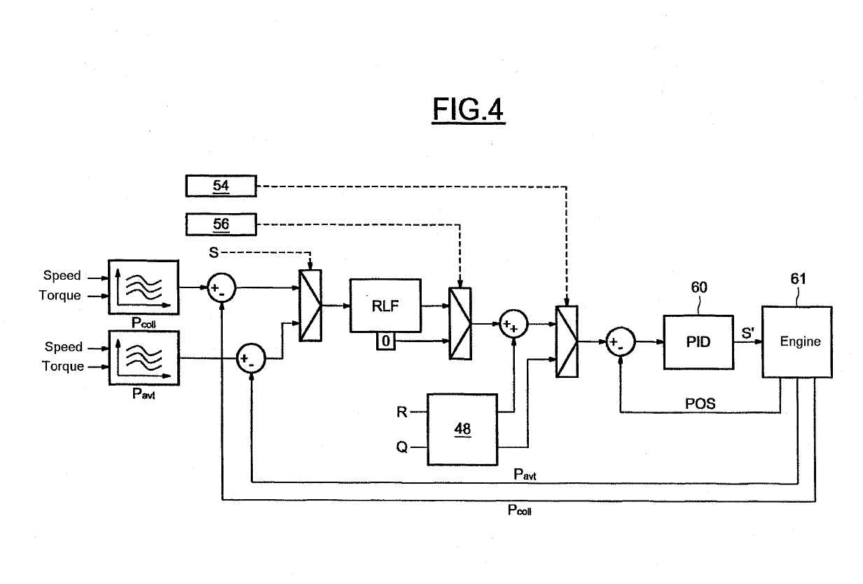

FIG. 4 is a block diagram illustrating the general architecture of the supercharging control device according to the invention; and

FIG. 5 is a block diagram of a fuzzy logic regulator incorporated into the supercharging pressure regulator according to the invention.

FIG. 1 shows schematically the general structure of an internal combustion engine 10 of a motor vehicle, of the diesel type, and its cool air inlet and exhaust manifolds.

As is shown in this figure, the cool air inlet circuit in the engine 10 essentially comprises an air filter 12 supplying, by means of a turbocharger 14 and appropriate ducts 16, the inlet manifold 18 of the engine 10.

With respect to the exhaust manifold 20, the latter receives the exhaust gases originating from the combustion and discharges the latter to the outside, through the turbocharger 14 and a particle filter 22 designed to reduce the quantity of particles, particularly soot, discharged into the environment.

An optional heat exchanger 24 fitted to the duct 16 for supplying the inlet manifold 18 with cool air, is placed in heat exchange relation with the exhaust gases, so as to collect a portion of the calories transported by the latter.

The turbocharger essentially comprises a turbine 26 driven by the exhaust gases and a compressor 28 mounted on the same shaft as the turbine and compressing the air delivered through the air filter 12, for the purpose of increasing the quantity of air admitted to the cylinders of the engine.

Furthermore, the engine 10 is also associated with a circuit 30 for recirculation of the exhaust gases, used to reinject a portion of these gases into the inlet manifold 18 in order, in particular, to limit the quantity of nitrogen oxide produced while preventing the formation of smoke in the exhaust gases.

This circuit 30 comprises essentially a solenoid valve 32 which makes it possible to control the flow rate of recirculated exhaust gases.

Furthermore, an electronic control unit ECU, indicated by reference number 34, collects signals P_{coll} and Pₐᵥₜ for measuring the pressure prevailing respectively in the inlet manifold and upstream of the turbine 26 of the turbocharger, delivered by appropriate measurement sensors provided for this purpose (not shown). It acts on a member for adjusting the power of the exhaust gases, for example a waste gate or fins of the turbine 26 in order to regulate the value of the pressure prevailing in the inlet manifold 18 and upstream of the turbine 26 of the turbocharger 14 around respective set point values.

The ECU unit also controls the operation of the engine, in a manner known per se. It acts in particular on the solenoid valve 32 in order to regulate the quantity of gases recirculated and regulates the operating point of the engine.

The present patent application relates essentially only to the regulation of the supercharging pressure. Also, the following description of the ECU unit will relate directly only to the essential means making it possible to apply this regulation.

As shown in FIG. 1, the ECU electronic control unit 34 essentially comprises regulation means making it possible to regulate the supercharging pressure, that is to say the pressure in the inlet manifold 18, around a threshold value.

These regulation means essentially comprise a first regulation stage 36 and a second regulation stage 38 operating jointly in order to regulate the supercharging pressure.

Also provided is a third stage 40 limiting the pressure Pₐᵥₜ upstream of the turbine.

With reference to FIG. 2, the limitation of the pressure prevailing upstream of the turbine, provided by the third regulation stage 40, is active only when the pressure Pₐᵥₜ upstream of the turbine is greater than a first threshold value CONS1. In this case, the regulation of the supercharging pressure applied by the first stage 36 and second stage 38 of the ECU control unit 34 is deactivated. As will be described in detail below, these first 36 and second 38 stages are then positioned in an open loop, the turbocharger 14 then being piloted by the third stage 40 in order to limit the pressure upstream of the turbine.

On the contrary, the regulation of the pressure upstream of the turbine applied by the third stage 40 is deactivated when the pressure prevailing in the manifold P_{coll} is greater than or equal to a second set point value CONS2.

As will be indicated below, these regulation modes are applied as a function of a control signal S generated by the ECU as a function of the measured values Pₐᵥₜ and P_{coll} and the set points CONS1 and CONS2.

With reference to FIGS. 3, 4 and 5, a particular embodiment of a device for regulating the supercharging pressure according to the invention will now be described.

FIG. 3 shows the general architecture of the first regulation stage 36, while FIG. 4 shows an exemplary embodiment of the first stage 36, second stage 38 and third stage 40. In the embodiment illustrated, the third regulation stage 40 is incorporated into the first stage 36. It is however, possible to envisage producing these stages in the form of two distinct regulation modules.

Of the first stage 36 and second stage 38, one forms a slow regulation loop and the other a fast regulation loop.

In other words, the first regulation stage 36 is a relatively slow regulator, based on a regulator of the PID type or a fuzzy logic regulator which makes it possible to slave the supercharging pressure to a predetermined set point value. The second regulation stage 38 is, for its part, a relatively fast regulator of the PID type or a digital regulator of the RST type which makes it possible to ensure that a position for the turbine 26 controlled by the first regulation stage 36 is actually achieved. For example, the frequency of computation of the regulation means used to perform this task is faster than the frequency of computation used by the regulation means performing the rest of the regulation of the supercharging pressure.

Referring to FIG. 3, the slow loop regulator makes it possible to generate a command signal S′ intended for the turbine 26 in order either to regulate the supercharging pressure or to limit the pressure upstream of the turbine as a function of the result of the comparison between, on the one hand, the measurement of the pressure upstream of the turbine Pₐᵥₜ and the first set point value C1 of pressure upstream of the turbine and, on the other hand, between the measurement of the supercharging pressure P_{coll} and the second set point value CONS2 of manifold pressure or, in other words, the command signal S for limiting the pressure upstream of the manifold.

In other words, as indicated above, when the measurement value Pₐᵥₜ of the pressure upstream of the turbine is greater than the first threshold value CONS1, the regulation of the supercharging pressure is deactivated and the regulation of the pressure upstream of the turbine is activated in order to limit this pressure Pₐᵥₜ. On the other hand, when the value of the manifold pressure P_{coll} is greater than or equal to the second threshold value CONS2, the regulation of the pressure upstream of the turbine is deactivated and the regulation of supercharging pressure is activated.

In the exemplary embodiment illustrated in FIG. 3, the regulator is a regulator of the PID type. As will be indicated with reference to FIG. 4, a regulator of the fuzzy logic type could also be used.

With reference to FIG. 3, the regulator comprises a comparator 42 which makes the comparison between the set point of pressure upstream of the turbine CONS1 and the measurement of the pressure upstream of the turbine Pₐᵥₜ or a comparison between the pressure set point of the manifold CONS2 and the measurement of the manifold pressure P_{coll} as a function of the value of the pressure limitation command signal S.

As is known per se, the regulation is applied by means of an integrator 44 and a differentiator 46 in order to generate a command signal S′ intended for the turbine 26 in order to slave the manifold pressure to the corresponding set point CONS2 or the pressure upstream of the turbine to the corresponding set point CONS1.

Furthermore, to improve the response time of this regulation loop, a prepositioning value of the gate or of the fins of the turbine is added to the PID regulator. This prepositioning value is extracted from a cartography element 48 as a function of the engine speed R or the fuel flow rate Q. It is also possible to add corrections as a function of the atmospheric pressure, the temperature of the inlet air, etc.

This cartography element of prepositioning of the turbine 26 is incorporated into the ECU and makes it possible to obtain a first estimated value of the settings of the turbocharger as a function of the speed and flow rate and thereby to make the regulation easier. In addition, by correcting the value extracted from the cartography element as a function mainly of the atmospheric pressure and temperature, it is possible to refine the prepositioning value of the turbine as a function for example of the altitude or the ambient temperature. It will be noted that this prepositioning value of the turbine 26 makes it possible to position the turbocharger in an initial state that is valid during stable speeds and that therefore makes it possible to approach transitional speeds with a good setting at the outset.

The output of the regulator, and in particular of the differentiator 44 and of the cartography element 48 are added together by means of an adder 50 and are then presented at the input of a limiter 52 in order to fix the integral portion when saturation is reached.

It will be noted that, in the exemplary embodiment of the regulation of the supercharging pressure that has just been given, a measurement is taken of the supercharging pressure P_{coll} that is slaved to a corresponding set point value CONS2. It is also possible, as a variant, to estimate the supercharging pressure.

With reference to FIG. 4, the general architecture of the device for regulating the supercharging pressure according to the invention will now be described.

In the embodiment described in this figure, the slow loop and the regulator for limiting the pressure upstream of the turbine are based on the use of a fuzzy logic regulator instead of the PID regulator used in the embodiment described above with reference to FIG. 3.

This first slow regulator, which also incorporates a limitation of the pressure upstream of the turbine, is furthermore similar to the regulator of FIG. 3.

Therefore, as indicated above, it makes it possible either to slave the supercharging pressure or the manifold pressure to the corresponding set point value CONS2 or to slave the pressure upstream of the turbine to the set point value CONS1, as a function of the command value S (FIG. 2).

Furthermore, in this embodiment, this first stage incorporates transitional speed detection means, reference number 54, of the conventional type, making it possible, based on a measurement and a processing of the engine operating parameters, to detect the occurrence of transitional speeds. In this case, as indicated above, the slow loop is deactivated so that the turbine 26 is piloted based only on the fast loop. However, the possibility of positioning the turbine at a prepositioning value extracted from a cartography element 48 as a function of the engine speed and the fuel flow rate Q is retained.

This regulator also incorporates open loop/closed loop management means 56 associated with the transitional speed detection means 54 in order to pilot the operation of the slow regulation, either in open loop, or in closed loop. The choice of open loop/closed loop operation for regulating the supercharging pressure may be made as a function of multiple criteria. As indicated above, it is possible to switch to open loop when the engine operates at transitional speed; it is also possible to use engine load criteria, etc.

The second regulation stage 38, which forms a fast regulation loop, makes it possible to ensure that the value of supercharging pressure originating from the regulation loop is really achieved. This fast regulation loop is based on the use of a comparator 58 which makes a comparison between the expected position of the turbine actuator originating from the slow loop with a corresponding measurement POS of the actuator. A regulator 60 of the PID (Proportional, Integral, Differential) type makes it possible to slave the position of the actuator to a set point originating from the slow loop. It delivers a signal S′ for commanding the actuator of the turbine. For example, the signal generated is a pulse width modulated signal. It makes it possible for example to command the position of the fins of the turbine by means of an actuator 61 of the pneumatic or electric type.

With respect to the fuzzy logic regulator RLF included in the constitution of the slow regulation loop, it will be noted that such a regulator consists of an element of the conventional type, within the scope of those skilled in the art. It will not therefore be described in detail hereinafter. It will be noted however, as can be seen in FIG. 5, that it is based on the use of a regulator 62 that is associated with a differentiator 64 and an integrator 66. The signals originating from a subtractor 68, which carry out the computation between a measured signal and a set point signal, are presented at the input of the regulator 62. The regulator 62 is notified of the pressure difference and its time differential. If the slaving function that is sought has a dominant proportional term, the integrator 66 will be provided to complete the slaving. However, this integrator may be omitted. The output signal from the regulator 62 and the integrator 66 are then added by means of an adder 69 and then supplied to an output regulator 70 in order to be delivered as an input of the fast loop.

Reference may however be made to document EP-A-1 365 132 which describes the architecture of a fuzzy logic regulator in detail.

1-15. (canceled)

16. A method for controlling supercharging with air of an internal combustion engine of a motor vehicle fitted with a supercharging turbocharger including a turbine rotated by exhaust gases of the engine and a supercharging compressor driven by the turbine, the method comprising:
first regulating pressure prevailing in an inlet manifold of the engine around a set point value of supercharging pressure, the first regulating of the manifold pressure comprising a slow regulation and a fast regulation; and
second regulating pressure upstream of the turbine to limit a value of the pressure, the second regulating being applied as soon as the pressure upstream of the turbine exceeds a predetermined threshold value.

17. The method as claimed in claim 16, wherein the second regulating the pressure upstream of the turbine is deactivated as soon as the pressure in the manifold is greater than the supercharging pressure set point value.

18. The method as claimed in claim 16, wherein the slow regulation comprises a phase of generating the supercharging pressure set point and a regulation of the manifold pressure around the set point value.

19. The method as claimed in claim 18, wherein the set point value is extracted from a cartography element.

20. The method as claimed in claim 19, wherein the set point value is generated as a function of engine speed and fuel flow rate.

21. The method as claimed in claim 20, wherein the set point value is corrected as a function of ambient parameters, or as a function of temperature and atmospheric pressure.

22. The method as claimed in claim 18, wherein the first regulating the pressure in the manifold around the set point value is applied by a fuzzy logic or a regulator of PID type.

23. The method as claimed in claim 16, wherein a member for adjusting the pressure of the exhaust gases is set at a predetermined position extracted from a cartography element based on a value of operating parameters of the engine.

24. The method as claimed in claim 23, wherein the operating parameters comprise engine speed and fuel consumption.

25. The method as claimed in claim 16, wherein an operation is switched from the slow regulation to an open loop when the engine operates at transitional speed.

26. A device for controlling supercharging with air of an internal combustion engine of a motor vehicle fitted with a supercharging turbocompressor including a turbine driven by exhaust gases of the engine and a supercharging compressor driven by the turbine, the device comprising:
an electronic control unit comprising means for regulating pressure prevailing in an inlet manifold of the engine around a supercharging pressure set point value, wherein
the control unit comprises regulation means for limiting pressure value upstream of the turbine, the regulation being applied as soon as the pressure upstream of the turbine is greater than a threshold value, and
wherein the regulation of the pressure prevailing in the manifold comprises a slow regulation loop and a fast regulation loop.

27. The device as claimed in claim 26, wherein the slow loop comprises means for generating a supercharging pressure set point value based on operating parameters of the engine and means for slaving the manifold pressure around the threshold value.

28. The device as claimed in claim 27, wherein the means for slaving the pressure prevailing in the manifold to the set point value comprises a fuzzy logic element or a PID regulator.

29. The device as claimed in claim 26, further comprising a cartography element in which are stored position values of a member for regulating power of the exhaust gases as a function of operating parameters of the engine, and means for prepositioning the member based on a value extracted from the cartography element.

30. The device as claimed in claim 26, further comprising means for selectively commanding an operation from the slow regulation loop to a closed loop or to an open loop as a function of transitional or stabilized speed of the engine.
